(19) United States
(12) Patent Application Publication
(10) Pub. No.: US 2022/0247067 A1
(43) Pub. Date: Aug. 4, 2022

(54) BASE STATION ANTENNA

(71) Applicant: CommScope Technologies LLC, Hickory, NC (US)

(72) Inventors: Changfu CHEN, Suzhou (CN); Ligang WU, Suzhou (CN); Hangsheng WEN, Suzhou (CN)

(21) Appl. No.: 17/623,825

(22) PCT Filed: Jun. 30, 2020
(86) PCT No.: PCT/US2020/040205

§ 371 Date: Dec. 29, 2021

(30) Foreign Application Priority Data
Jul. 3, 2019 (CN) 201910594575.3

(51) Int. Cl. H01Q 1/24; H01Q 15/08; H01Q 1/42; H01Q 21/06

(52) U.S. Cl. CPC H01Q 1/246; H01Q 21/061; H01Q 1/42; H01Q 15/08

(57) ABSTRACT

A base station antenna comprises an array of radiating elements configured to emit electromagnetic radiation and an RF lens positioned to receive the electromagnetic radiation. The RF lens has a first surface facing the array of radiating elements and a second surface opposite the first surface. The RF lens is divided into a plurality of portions that extend from the first surface to the second surface, respectively, the plurality of portions having respective refractive indices for the electromagnetic radiation, wherein the plurality of portions are arranged, in a width direction of the RF lens, such that a first of the plurality of portions having the highest refractive index is in a middle portion of the radio frequency lens and others of the plurality of portions having lower refractive indices are on either side of the first of the plurality of portions.

### CROSS-REFERENCE TO RELATED APPLICATION

The present application claims priority to Chinese Patent Application No. 201910594575.3, filed Jul. 3, 2019, the entire content of which is incorporated herein by reference as if set forth fully herein.

### FIELD

The present invention relates to cellular communication systems and, more particularly, to base station antennas.

### BACKGROUND

Each cell in a cellular communication system has one or more antennas that are configured to provide two-way wireless radio frequency (“RF”) communication to mobile users geographically located within the cell. While a single antenna may be used to provide cellular service throughout the cell, multiple antennas are typically used and each antenna is configured to provide service to a respective sector of the cell. Typically, the multiple sector antennas are arranged on a tower and serve respective sectors by forming radiation beams (also referred to herein as “antenna beams”) that face outwardly in different directions in the horizontal or “azimuth” plane.

FIG. 1A is a schematic diagram of a conventional base station 10. As shown in FIG. 1A, base station 10 includes an antenna 20 that may be mounted on a raised structure 30. In the depicted embodiment, the raised structure 30 is a small antenna tower, but it will be appreciated that a wide variety of mounting locations may be used including, for example, utility poles, buildings, water towers and the like. As is further shown in FIG. 1A, the base station 10 also includes base station equipment, such as baseband units 40 and radios 42. A single baseband unit 40 and a single radio 42 are shown in FIG. 1A to simplify the drawing, but it will be appreciated that more than one baseband unit 40 and/or radio 42 may be provided. Additionally, while the radio 42 is shown as being co-located with the baseband unit 40 at the bottom of the raised structure 30, it will be appreciated that in other cases the radio 42 may be a remote radio head that is mounted on the raised structure 30 adjacent the antenna 20. The baseband unit 40 may receive data from another source such as, for example, a backhaul network (not shown) and may process this data and provide a data stream to the radio 42. The radio 42 may generate RF signals that include the data encoded therein and may amplify and deliver these RF signals to the antenna 20 for transmission via a cabling connection 44. It will also be appreciated that the base station 10 of FIG. 1A will typically include various other equipment (not shown) such as, for example, a power supply, backup batteries, a power bus, Antenna Interface Signal Group (“AISG”) controllers and the like.

Typically, a base station antenna includes one or more phase-controlled arrays of radiating elements, with the radiating elements arranged in one or more vertical columns (a “column” herein, unless otherwise specified, refers to a column oriented in a vertical direction) when the antenna is mounted for use. Herein, “vertical” refers to a direction that is perpendicular relative to the plane defined by the horizon. Elements in the antenna that are referred to as being arranged, disposed or extending in a vertical direction means that when the antenna is mounted on a support structure for operation and there is no physical tilt, the elements are arranged, disposed or extending in a direction that is perpendicular relative to the plane defined by the horizon.

In a cellular base station having a conventional “3-sector” configuration, each sector antenna typically has a beamwidth of about 65° in the azimuth plane (a “beamwidth” herein, unless otherwise specified, refers to a half-power (−3 dB) beamwidth), as shown in FIG. 1B. A base station may alternatively have a 6 sector configuration that may be used to increase system capacity. In a 6-sector cellular configuration, so-called “dual-beam” antennas are typically used that generate two separate antenna beams that point in different directions in the azimuth plane. Each antenna beam may have a narrower beamwidth as compared to the antenna beams generated by antennas used in 3-sector configurations, for example, a beamwidth of about 33°, and the two antenna beams may point towards the middle of respective adjacent sectors in the azimuth plane. Since a dual-beam antenna covers two sectors, three dual-beam antennas can provide full coverage for a 6-sector configuration base station. An exemplary radiation pattern in the azimuth plane for a dual-beam antenna is shown in FIG. 1C. As shown in FIG. 1C, the radiation pattern has two antenna beams that have different azimuth boresight pointing directions, and each antenna beam has a narrower beamwidth of about 33°. The two antenna beams cover 2 adjacent sectors in a cell with 6 sectors.

Antenna beams having narrower beamwidths may be obtained by using multiple columns of radiating elements in a base station antenna, for example 3 or 4 columns of radiating elements. It is also feasible to obtain a narrower beamwidth by using an RF lens in a base station antenna.

### SUMMARY

A first aspect of this invention is to provide a base station antenna. The base station antenna may comprise: an array of radiating elements configured to emit electromagnetic radiation; and an RF lens positioned to receive the electromagnetic radiation, the RF lens having a first surface facing the array of radiating elements and a second surface opposite the first surface, the RF lens being divided into a plurality of portions that extend from the first surface to the second surface, respectively, the plurality of portions having respective refractive indices for the electromagnetic radiation, wherein the plurality of portions are arranged, in a width direction of the RF lens, such that a first of the plurality of portions having the highest refractive index is in a middle portion of the radio frequency lens and others of the plurality of portions having lower refractive indices are on either side of the first of the plurality of portions.

A second aspect of this invention is to provide a base station antenna. The base station antenna may comprise: an array of radiating elements; an RF lens positioned to receive electromagnetic radiation from each radiating element in the array of radiating elements, the RF lens having a first surface facing the array of radiating elements and a second surface opposite the first surface, wherein the RF lens is divided into first to third portions respectively extending from the first surface to the second surface, extending from an upper end of the RF lens in a vertical direction to a lower end thereof, and having first to third dielectric constants, the first portion being substantially positioned in a middle region of the RF lens, the second and third portions being respectively positioned on opposed sides of the first portion in a width direction of the RF lens, and wherein the first dielectric constant is greater than both the second dielectric constant and the third dielectric constant.

A third aspect of this invention is to provide a base station antenna. The base station antenna may comprise: one or more linear arrays of radiating elements configured to emit electromagnetic radiation; an RF lens positioned to receive the electromagnetic radiation, the RF lens comprising a plurality of strip portions that extend substantially parallel to the linear arrays of radiating elements, wherein the plurality of strip portions each have respective refractive indices for the electromagnetic radiation, and the plurality of strip portions are arranged along a width direction of the RF lens such that a first of the plurality of strip portions having the highest refractive index is in a middle of the radio frequency lens and others of the plurality of strip portions having lower refractive indices are on either side of the first of the plurality of strip portions.

A fourth aspect of this invention is to provide a base station antenna. The base station antenna may comprise: a first array of radiating elements configured to emit electromagnetic radiation to generate a first beam; a second array of radiating elements configured to emit electromagnetic radiation to generate a second beam; a first backplane, the first array of radiating elements being disposed on an outer surface of the first backplane; a second backplane, the second array of radiating elements being disposed on an outer surface of the second backplane; a first RF converging lens positioned to receive the electromagnetic radiation emitted by the first array of radiating elements; and a second RF converging lens positioned to receive the electromagnetic radiation emitted by the second array of radiating elements, wherein the first and second backplanes are positioned such that an angle between the outer surface of the first backplane and the outer surface of the second backplane is greater than 180 degrees, such that a horizontal pointing direction of the first beam is different from a horizontal pointing direction of the second beam.

A fifth aspect of this invention is to provide a base station antenna. The base station antenna may comprise: a first array of radiating elements configured to operate in a first frequency band and emit electromagnetic radiation to generate a first beam; a second array of radiating elements configured to operate in the first frequency band and emit electromagnetic radiation to generate a second beam; a third array of radiating elements configured to operate in a second frequency band that is different from the first frequency band; a first backplane, the first array of radiating element being disposed on an outer surface of the first backplane; a second backplane, the second array of radiating elements being disposed on an outer surface of the second backplane; and a third backplane, the third array of radiating elements being disposed on an outer surface of the third backplane, wherein the first and second backplanes are positioned such that an angle between the outer surface of the first backplane and the outer surface of the second backplane is greater than 180 degrees, such that a direction of the first beam is different from that of the second beam; and the third backplane is positioned between the first and second backplanes.

Further features of the present invention and advantages thereof will become apparent from the following detailed description of exemplary embodiments with reference to the attached drawings.

### BRIEF DESCRIPTION OF THE DRAWING

FIG. 1A is a simplified schematic diagram showing a conventional base station in a cellular communication system.

FIG. 1B is an exemplary signal radiation pattern in an azimuth plane of each sector antenna in a conventional 3-sector cellular configuration.

FIG. 1C is an exemplary signal radiation pattern in an azimuth plane of each dual-beam antenna in a conventional 6-sector cellular configuration.

FIG. 2A is a highly simplified horizontal cross-sectional view of a base station antenna according to an embodiment of the present invention.

FIG. 2B is a schematic view of an angle between backplanes in the base station antenna shown in FIG. 2A.

FIG. 3A is a perspective view of an RF lens in the base station antenna shown in FIG. 2A, where a plurality of portions included in the RF lens are illustrated.

FIG. 3B is a schematic view showing electrical thicknesses of the plurality of portions included in the RF lens shown in FIG. 3A.

FIGS. 4A through 4D are highly simplified horizontal cross-sectional views of RF lenses in base station antennas according to some embodiments of the present invention.

FIG. 5 is a plan view of an RF lens in a base station antenna according to a further embodiment of the present invention, where a plurality of portions included in the RF lens are illustrated.

FIGS. 6 and 7 are highly simplified horizontal cross-sectional views of base station antennas according to some embodiments of the present invention, where the radome is removed.

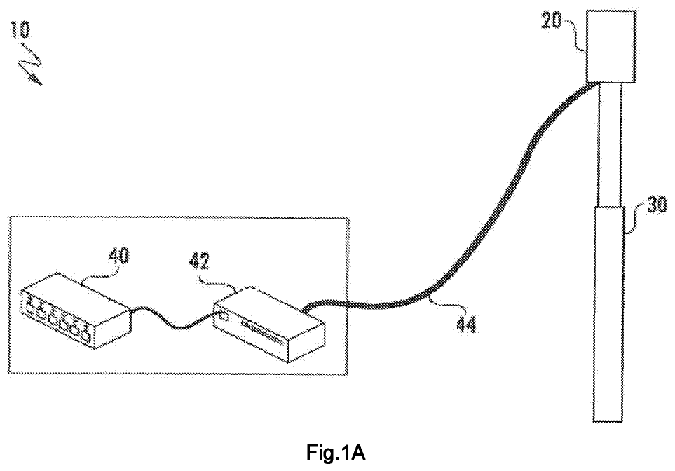

Note that, in some cases the same elements or elements having similar functions are denoted by the same reference numerals in different drawings, and description of such elements is not repeated. In some cases, similar reference numerals and letters are used to refer to similar elements, and thus once an element is defined with reference to one figure, it need not be further discussed with reference to subsequent figures.

The position, size, range, or the like of each structure illustrated in the drawings may not be drawn to scale. Thus, the invention is not necessarily limited to the position, size, range, or the like as disclosed in the drawings.

### DETAILED DESCRIPTION

The present invention will be described with reference to the accompanying drawings, which show a number of example embodiments thereof. It should be understood, however, that the present invention can be embodied in many different ways, and is not limited to the embodiments described below. Rather, the embodiments described below are intended to make the disclosure of the present invention more complete and fully convey the scope of the present invention to those skilled in the art. It should also be understood that the embodiments disclosed herein can be combined in any way to provide many additional embodiments.

The terminology used herein is for the purpose of describing particular embodiments, but is not intended to limit the scope of the present invention. All terms (including technical terms and scientific terms) used herein have meanings commonly understood by those skilled in the art unless otherwise defined. For the sake of brevity and/or clarity, well-known functions or structures may be not described in detail.

Herein, when an element is described as located “on” “attached” to, “connected” to, “coupled” to or “in contact with” another element, etc., the element can be directly located on, attached to, connected to, coupled to or in contact with the other element, or there may be one or more intervening elements present. In contrast, when an element is described as “directly” located “on”, “directly attached” to, “directly connected” to, “directly coupled” to or “in direct contact with” another element, there are no intervening elements present. In the description, references that a first element is arranged “adjacent” a second element can mean that the first element has a part that overlaps the second element or a part that is located above or below the second element.

Herein, the foregoing description may refer to elements or nodes or features being “connected” or “coupled” together. As used herein, unless expressly stated otherwise, “connected” means that one element/node/feature is electrically, mechanically, logically or otherwise directly joined to (or directly communicates with) another element/node/feature. Likewise, unless expressly stated otherwise, “coupled” means that one element/node/feature may be mechanically, electrically, logically or otherwise joined to another element/node/feature in either a direct or indirect manner to permit interaction even though the two features may not be directly connected. That is, “coupled” is intended to encompass both direct and indirect joining of elements or other features, including connection with one or more intervening elements.

Herein, terms such as “upper”, “lower”, “left”, “right”, “front”, “rear”, “high”, “low” may be used to describe the spatial relationship between different elements as they are shown in the drawings. It should be understood that in addition to orientations shown in the drawings, the above terms may also encompass different orientations of the device during use or operation. For example, when the device in the drawings is inverted, a first feature that was described as being “below” a second feature can be then described as being “above” the second feature. The device may be oriented otherwise (rotated 90 degrees or at other orientation), and the relative spatial relationship between the features will be correspondingly interpreted.

Herein, the term “A or B” used through the specification refers to “A and B” and “A or B” rather than meaning that A and B are exclusive, unless otherwise specified.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the detailed description.

Herein, the term “substantially”, is intended to encompass any slight variations due to design or manufacturing imperfections, device or component tolerances, environmental effects and/or other factors. The term “substantially” also allows for variation from a perfect or ideal case due to parasitic effects, noise, and other practical considerations that may be present in an actual implementation.

Herein, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, steps, operations, elements, and/or components, but do not preclude the presence or addition of one or more other features, steps, operations, elements, components, and/or groups thereof.

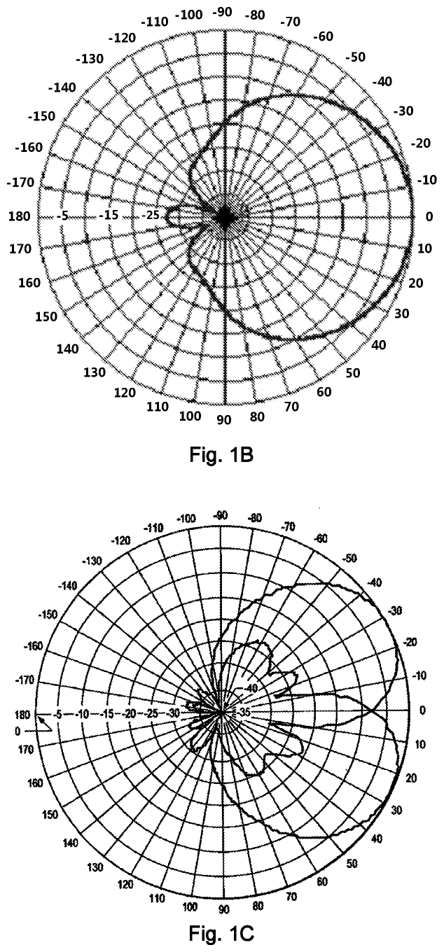

Herein, reference coordinates used to describe a length, width and thickness of a base station antenna are the Cartesian coordinates with x′, y′ and z′ axes shown in FIG. 2A. The direction of the x′ axis is the width direction of a base station antenna, the direction of the y′ axis is the length direction of the base station antenna, and the direction of the z′ axis is the thickness direction of the base station antenna. Further, the direction of the y′ axis is also described as a vertical direction, the plane defined by the x′ and z′ axes is described as a horizontal plane or a horizontal direction, and the positive direction of the z′ axis is described as the outer side of the base station antenna. Reference coordinates used to describe lengths, widths, and thicknesses of the lens 131, the backplane 121, and the array of radiating elements 111 are the Cartesian coordinates with x, y and z axes shown in FIG. 2A. The direction of the x axis is the width direction, the direction of the y axis is the length direction, and the direction of the z axis is the thickness direction of these components. Further, the positive and negative directions of the z axis are described as the outer side and the inner side of these components, respectively. It will be appreciated that reference coordinates used to describe lengths, widths, and thicknesses of the lens 132, the backplane 122, and the array of radiating elements 112 in FIG. 2A are Cartesian coordinates (not shown) that is symmetric with the Cartesian coordinates with x, y and z axes about the plane defined by y′ and z′ axes.

According to an embodiment of the present invention, a base station antenna may comprise an RF lens. The RF lens is positioned to receive electromagnetic radiation from an array of radiating elements. The RF lens includes a first surface facing the array of radiating elements and a second surface opposite the first surface. The RF lens is divided into a plurality of portions extending from the first surface to the second surface, respectively. The plurality of portions have respective refractive indices for electromagnetic radiation. The plurality of portions are arranged, in a width direction of the RF lens, from a middle of the RF lens to at least one side thereof, such that the refractive indices of the RF lens decrease from the middle of the RF lens to the at least one side. Due to this configuration, electromagnetic radiation from the radiating elements enters the RF lens from somewhere on the first surface of the RF lens, and travels not along a straight line but toward the middle portion of the RF lens having a larger refractive index. Accordingly, even if the RF lens does not have an outwardly curved surface and instead, for example, has a flat plate shape, it may have a focusing effect on electromagnetic radiation from the radiating elements. The base station antennas according to embodiments of the present invention may allow a reduction in the thickness of the RF lens compared to base station antennas that include a spherical lens, a hemispherical lens, or a cylindrical lens having a spherical or hemispherical cross section, which is advantageous in reducing the size of the base station antenna and improving heat dissipation.

The plurality of portions of the RF lens included in the base station antennas according to embodiments of the invention respectively extend from the first surface to the second surface, which facilitates manufacture of the lens. For example, the plurality of portions having respective refractive indices may be separately fabricated, and then these portions are attached (e.g., high temperature pressed, bonded, etc.) together to form the RF lens.

In some embodiments, the RF lens may be formed as at least a portion of the radome of the base station antenna, which houses the array of radiating elements. This is advantageous for simplifying the configuration of the base station antenna, and for reducing the size and facilitating the assembly of the antenna.

In some embodiments, the RF lens may include dielectric materials. The plurality of portions each include dielectric materials having respective dielectric constants, such that the plurality of portions each have respective refractive indices. A gradual change of the dielectric constants in the dielectric materials may be realized by incorporating a dielectric material having a higher dielectric constant into a dielectric material having a lower dielectric constant (or an opposite process), for example, by incorporating glass or ceramic into a fluoro-polyethylene (PDFE).

According to further embodiments of the present invention, dual-beam base station antennas that include RF lenses are provided. First and second arrays of radiating elements for respectively generating first and second antenna beams are disposed on respective first and second backplanes. An angle between an outer surface of the first backplane and an outer surface of the second backplane is greater than 180 degrees. The antenna also includes first and second RF converging lenses positioned to receive electromagnetic radiation from the respective first and second arrays of radiating elements. As used herein, “RF converging lens” refers to an RF lens that is capable of converging (focusing) electromagnetic radiation.

Compared to a dual-beam base station antenna that does not include an RF lens, the base station antenna according to the embodiment of the present invention may allow the first and second arrays of radiating elements to have fewer columns of radiating elements so as to generate an antenna beam having a narrower azimuth beamwidth (for example, an azimuth beamwidth of 33°). For example, each array of radiating elements in a dual-beam base station antenna that does not include an RF lens typically includes three or four columns of radiating elements, so as to generate an antenna beam with an azimuth beamwidth of 33°. In contrast, each array of radiating elements in a dual-beam base station antenna including an RF lens, only needs to include one or two columns of radiating elements, so as to generate an antenna beam with an azimuth beamwidth of 33°. This is advantageous in reducing the size of the dual-beam base station antenna and also in simplifying the feed network of the antenna.

Since the angle between the outer surface of the first backplane and the outer surface of the second backplane is greater than 180 degrees, the antenna beam generated by the first array of radiating elements is directed away from the second array of radiating elements, and the antenna beam generated by the second array of radiating elements is directed away from the first array of radiating elements. Therefore, interferences between the electromagnetic radiation emitted by the first and second arrays of radiating elements may be reduced. The first and second RF converging lenses cause the first and second antenna beams to converge more toward their respective maximum radiation directions, which facilitates further reducing the interferences between the electromagnetic radiation of the first and second arrays of radiating elements.

According to still further embodiments of the invention, multi-band base station antennas are provided. First and second arrays of radiating elements that operate in a first frequency band are mounted on first and second backplanes, respectively. An angle between an outer surface of the first backplane and an outer surface of the second backplane is greater than 180 degrees. A third array of radiating elements that operates in a second frequency band is mounted on a third backplane. The third backplane is positioned between the first and second backplanes, such that a third antenna beam that is generated by the third array of radiating elements is between first and second antenna beams that are respectively generated by the first and second arrays of radiating elements in an azimuth plane, which facilitates reducing interference between the electromagnetic radiation of the first to third arrays of radiating elements.

In some embodiments, the multi-band base station antenna further includes first and second RF converging lenses positioned to receive electromagnetic radiation from the first and second arrays of radiating elements, respectively. The RF converging lens may allow for a smaller size of the corresponding array of radiating elements, for example, allow for fewer columns of radiating elements in the array as described above, which saves space within the base station antenna so as to provide room the third array of radiating elements. Even in the case where the second frequency band in which the third array of radiating elements operates is at lower frequencies than the first frequency band in which the first and second arrays of radiating elements operate, that is, the radiating elements in the third array of radiating elements have relatively large sizes, the space saved by utilizing the RF converging lenses may allow for the arrangement of the third array of radiating elements.

FIGS. 2A and 2B schematically illustrate the configuration of a base station antenna according to an embodiment of the present invention. The base station antenna includes three arrays of radiating elements 111 to 113 which are mounted on backplanes 121 to 123, respectively. The array of radiating elements 111 includes two columns of radiating elements, with each column including a plurality of radiating elements 114 positioned in a vertical direction. The array 111 is configured to operate in a first frequency band (e.g., the 1695-2690 MHz band, the 3300-3800 MHz band, the 5100-5800 MHz band, etc.) and generate a first antenna beam having a first azimuth pointing direction (i.e., the maximum radiation of the antenna beam is directed toward a first angle in the azimuth plane). The array of radiating elements 112 includes two columns of radiating elements, with each column including a plurality of radiating elements 114 positioned in a vertical direction. The array 112 is configured to operate in the first frequency band that is the same frequency band that the array 111 is configured to operate in and to generate a second antenna beam having a second azimuth pointing direction. The array of radiating elements 113 includes a column of radiating elements that includes a plurality of radiating elements 115 positioned in a vertical direction. The array 113 is configured to operate in a second frequency band (e.g., the 694-960 MHz band). In the depicted embodiment, the second frequency band is lower than the first frequency band such that the radiating elements 115 are larger than the radiating elements 114.

In the depicted embodiment, each of the arrays 111 and 112 includes two columns of radiating elements. It will be appreciated, however, that each array 111, 112 may include more or less columns of radiating elements, and the number of radiating elements included in each column may be designed as needed (e.g., based on a desired elevation beamwidth). In the depicted embodiment, the operating frequency band of the radiating elements 115 in the array 113 is lower than the operating frequency band of the radiating elements 114 in the arrays 111 and 112. It will be appreciated, however, that the operating frequency band of the radiating elements 115 in the array 113 may be higher than or the same as the operating frequency band of the radiating elements 114 in the arrays 111 and 112 in other embodiments. Any suitable radiating element designs may be used in each of the arrays of radiating elements 111, 112, 113, including, for example, dipoles, crossed dipoles, patch radiating elements, and the like.

The radiating elements may extend outwardly from the backplanes 121 to 123 on which they are mounted. The backplanes 121 to 123 may be part of a reflector assembly of the base station antenna, for example, a reflector and a ground plane for the radiating elements mounted thereon. Each of the arrays 111 to 113 is mounted on a corresponding one of the backplanes 121 to 123, and may be vertically oriented with respect to the horizon when the base station antenna is mounted for use.

The backplanes 121 and 122 are positioned such that an angle between an outer surface of the backplane 121 and an outer surface of the backplane 122 is greater than 180 degrees. It will be appreciated that since each backplane 121, 122 has a physical thickness, the angle between the outer surfaces of the backplane refers to an angle that does not pass through the thickness of either of the backplanes 121, 122. For example, as shown in FIG. 2B, the angle between the outer surface of the backplane 121 and the outer surface of the backplane 122 refers to the angle α instead of the angle β. The angle α is greater than 180 degrees, so that the maximum radiation direction of the antenna beam generated by the array 111 in the azimuth plane (for example, the direction A shown in FIG. 2B) is away from the array 112, and the maximum radiation direction of the antenna beam generated by the array 112 in the azimuth plane (for example, the direction B shown in FIG. 2B) is away from array 111, so that interference between electromagnetic radiation emitted by arrays 111, 112 may be reduced.

The backplane 123 is positioned between the backplanes 121 and 122. The backplane 123 includes a first vertical side portion 123-1 and a second vertical side portion 123-2 at opposed sides thereof in the width direction. In the depicted embodiment, the first vertical side portion 123-1 is mechanically connected to a corresponding vertical side portion of the backplane 121, and the second vertical side portion 123-2 is mechanically connected to a corresponding vertical side portion of the backplane 122. The backplane 123 is oriented substantially along the width direction of the base station antenna, and the angle between the outer surface of the backplane 121 and the outer surface of the backplane 123 is substantially equal to the angle between the outer surface of the backplane 122 and the outer surface of the backplane 123. Thus, in the azimuth plane, the maximum radiation direction of the antenna beam generated by the array 113 may be about midway between the maximum radiation directions of the antenna beams generated by the arrays 111 and 112.

The base station antenna further includes RF lenses 131 and 132. The RF lens 131 is positioned to receive electromagnetic radiation emitted by the array 111, and the RF lens 132 is positioned to receive electromagnetic radiation emitted by the array 112. The RF lenses 131 and 132 allow the respective antenna beams to focus the electromagnetic radiation emitted by the respective arrays 111, 112 toward the respective maximum radiation directions of the arrays 111, 112. In order to completely receive the electromagnetic radiation emitted by the respective arrays 111 and 112, a length of each of the RF lenses 131 and 132 (which may be the maximum length when its upper and/or lower edges are uneven-shaped) is greater than or equal to the length of the respective arrays 111 and 112. In some embodiments, RF lens 131 and/or RF lens 132 may include a plurality of RF lenses that are arranged in a vertical direction, and the total length of the plurality of RF lenses is greater than or equal to the length of the array 111 or 112. Further, the width of each of the RF lenses 131 and 132 (which may be the maximum width when its left and/or right edges are uneven-shaped) is greater than or equal to the width of the respective arrays 111 and 112. In some embodiments, the width of the RF lenses 131 and 132 may be 1.2 to 1.8 times the width of its corresponding array 111, 112. The distance between each of the RF lenses 131 and 132 to the respective arrays 111 and 112 may be designed as needed. For example, the RF lenses 131 and 132 may be positioned in close proximity to the respective arrays 111 and 112, such that, for example, the most forward portions of the radiating elements 114 in the arrays 111 and 112 may contact, or nearly contact, the inner surfaces of the RF lenses 131 and 132. As another example, the RF lenses 131 and 132 may be positioned at a distance from the respective arrays 111 and 112, such that the distance from the most forward portions of the radiating elements 114 in the arrays 111, 112 to the inner surface of the corresponding RF lenses 131, 132 is between 50 mm and 150 mm.

Each of the RF lenses 131 and 132 includes a first surface facing the respective arrays 111 and 112 (e.g., surface 131-1 of RF lens 131) and a second surface opposite the first surface (e.g., surface 131-2 of RF lens 131). In the depicted embodiment, the first surface and the second surface are substantially flat surfaces that are substantially parallel to each other. It will be appreciated that the RF lenses 131 and 132 may be lenses having other shapes that are capable of focusing electromagnetic radiation. For example, the RF lenses 131 and 132 may be a spherical lens, a hemispherical lens, a cylindrical lens or the like. The RF lenses 131 and 132 may be lenses having a substantially uniform refractive index (herein referred to as a refractive index with respect to the received electromagnetic radiation), or lenses having varying refractive indices. Further, it will be appreciated that the RF lenses 131 and 132 may have different shapes and characteristics from each other.

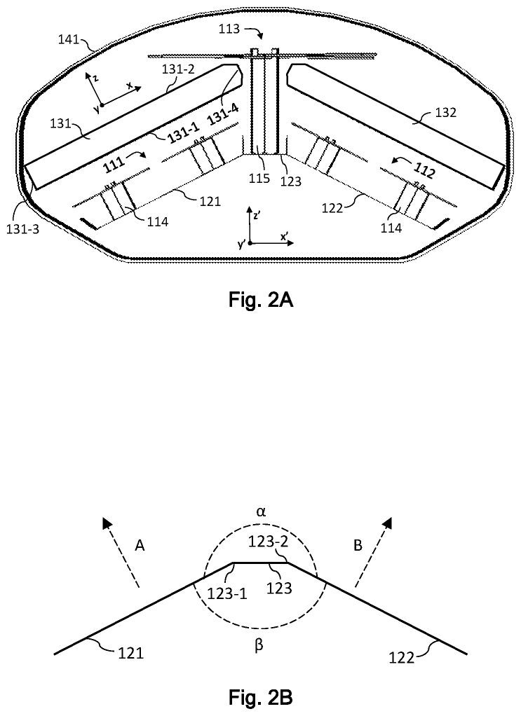

FIG. 3A is a perspective view of the RF lens 131. The RF lens 131 is divided into a plurality of portions 11 to 14 that extend from the surface 131-1 to the surface 131-2, respectively. The plurality of portions 11 to 14 have respective refractive indices n1 to n4 for electromagnetic radiation that is received by the RF lens 131. The plurality of portions 11 to 14 are arranged, in the width direction of the RF lens 131, from the middle of the lens 131 to one or both sides 131-3 and 131-4 of the lens 131, so that the refractive indices of the lens 131 decrease in stepwise fashion from the middle of the lens 131 to one or both sides 131-3, 131-4 of the lens 131. In the depicted embodiment, the physical thicknesses of the plurality of portions 11 to 14 are equal and the refractive indices having a relation of n1>n2>n3>n4, such that the electrical thicknesses h1 to h4 of the plurality of portions 11 to 14 have a relation of h1>h2>h3>h4, as shown in FIG. 3B. The “electrical thickness” of a portion of an RF lens refers to a distance that electromagnetic radiation passes in a vacuum, which is derived by converting a distance that the electromagnetic radiation passes in a medium that is not vacuum, and therefore the electrical thickness is numerically equal to the product of the physical thickness and the refractive index of the medium. It can be seen that the RF lens 131 may be substantially equivalent to a stepwise convex lens having a uniform refractive index, and thus the RF lens 131 is capable of focusing electromagnetic radiation. Accordingly, an RF lens having a similar configuration, even if its physical thickness is not gradually reduced from the middle to the sides as is the case with a conventional convex lens, or even if its physical thicknesses increases from the middle to the both sides, may still be capable of focusing electromagnetic radiation. In the depicted embodiment, the physical thickness of the RF lens 131 from the middle of the lens 131 to the sides 131-3 and 131-4 is substantially constant. The thickness and refractive index of each portion of the RF lens 131 may be designed according to requirements. For example, the thickness of each portion 11-14 may be between 10 mm and 50 mm.

In the embodiment depicted in FIG. 3A, from the middle of the RF lens 131 to the side 131-3 and from the middle to the side 131-4, the lens 131 has a symmetric distribution of refractive indices. It will be appreciated that, in other embodiments, the RF lens may have different distributions of refractive indices from the middle to both sides. The refractive indices n1 to n4 of the plurality of portions 11 to 14 may be linear, parabolic, or hyperbolically stepwise reduced in example embodiments. It is also possible that two or more adjacent ones of the refractive indices n1 to n4 may be the same. In the depicted embodiment, the RF lens is divided into four portions 11 through 14 from the middle of the lens 131 to the opposed sides 131-3, 131-4. It will be appreciated that, in other embodiments, the RF lens may be divided into more or fewer portions, for example, 2 to 10 portions.

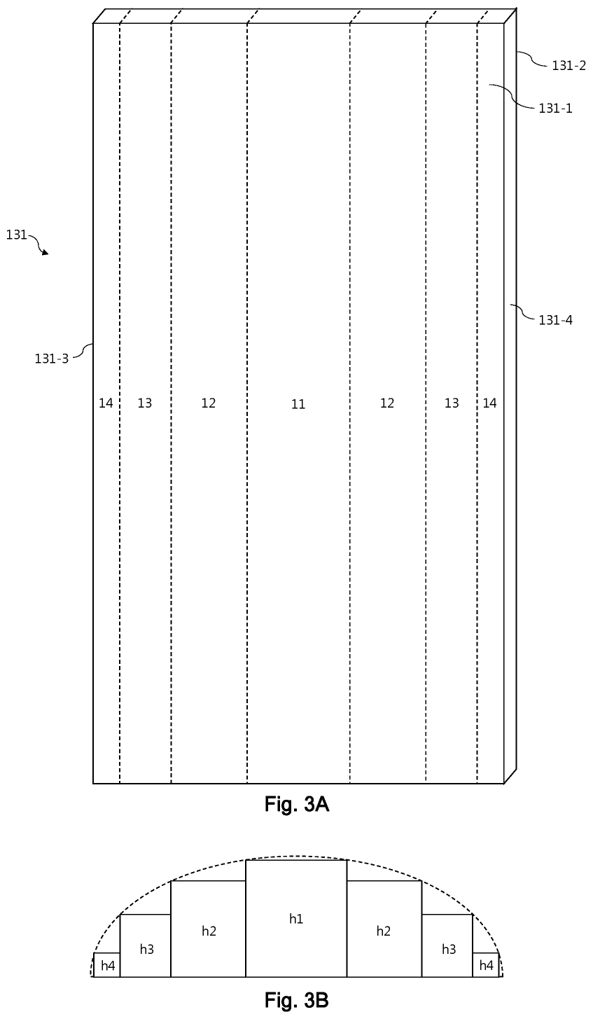

In the depicted embodiment, the first and second surfaces 131-1, 131-2; 132-1, 132-2 of the respective RF lenses 131 and 132 are substantially flat surfaces that are substantially parallel to each other, such that the RF lenses 131 and 132 are flat. It will be appreciated that either or both RF lenses 131, 132 may have another shape. FIGS. 4A to 4D illustrate cross-sectional shapes of RF lenses according to further example embodiments of the present invention. As shown in FIG. 4A, the surface 20-1 of RF lens 20 (which may be a surface facing the array of radiating elements or an opposite surface) is substantially flat, and the opposite surface 20-2 is outwardly curved, such that the RF lens 20 may focus electromagnetic radiation that received by it even if it has a substantially uniform refractive index. From the middle to each side of the lens 20, the lens 20 is divided into four portions 21 to 24 that respectively extend from the surface 20-1 to the surface 20-2, each portion having a respective refractive index. From the portion 21 to the portion 24, the refractive indices may gradually decrease. Thus, from the middle to each side of the lens 20, the lens 20 has not only decreased refractive indices but also decreased thicknesses, which is advantageous for enhancing the focusing effect on the electromagnetic radiation. As shown in FIG. 4B, the surfaces 30-1 and 30-2 of the RF lens 30 are both outwardly curved. From the middle to each side of the lens 30, the lens 30 is divided into three portions 31 to 33 that respectively extend from the surface 30-1 to the surface 30-2, each portion having a respective refractive index. From the portion 31 to the portion 33, the refractive indices gradually decrease. As shown in FIG. 4C, the surface 40-1 of the RF lens 40 (which may be a surface facing the array of radiating elements or an opposite surface) is substantially flat, and the middle portion of the opposite surface 40-2 is substantially flat and the two side portions slope toward the surface 40-1. From the middle to each side of the lens 40, the lens 40 is divided into two portions 41 to 42 that respectively extend from the surface 40-1 to the surface 40-2, and the refractive index of the portion 41 is greater than that of the portion 42. As shown in FIG. 4D, the surface 50-1 of the RF lens 50 (which may be the surface facing the array or an opposite surface) and the opposite surface 50-2 are both outwardly curved, such that the entirety of the lens 50 is outwardly curved. From the middle to each side of the lens 50, the lens 50 is divided into eight portions 51 to 58 that respectively extend from the surface 50-1 to the surface 50-2, each portion having a respective refractive index. From the portion 51 to the portion 58, the refractive indices gradually decrease. The thicknesses from the portion 51 to the portion 58 may be substantially constant, gradually decreasing, gradually increasing, not varying in a singular tendency, irregularly varying or the like.

In some embodiments, at least one of the RF lenses 131 and 132 is formed as at least a portion of a radome 141 of the antenna, wherein the radome 141 is configured to house the arrays of radiating elements 111 to 113. The RF lens that is formed as at least a portion of the radome 141 may have, for example, a cross section as shown in FIG. 4D or other cross sections having a suitable configuration. The RF lens is formed as a portion of the radome, which may facilitate simplifying the configuration and assembly of the base station antenna, further reducing the size of the base station antenna, and which may also improve heat dissipation.

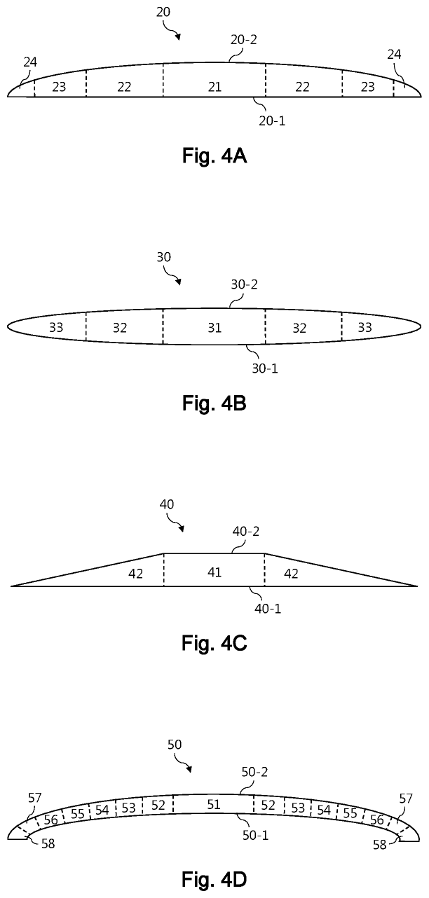

In embodiments depicted in FIGS. 3A and 4A to 4D, the plurality of portions (e.g., portions 11 to 14 of RF lens 131 of FIG. 3A) extend from an upper end to a lower end of the RF lens 131 in the vertical direction, that is, extend throughout the whole length of the lens 131. It will be appreciated that, in other embodiments, the plurality of portions included in the RF lens may not extend throughout the whole length of the lens. FIG. 5 is a plan view of an RF lens 60 according to further embodiments of the present invention. The RF lens 60 is divided into three sections 60-1 to 60-3 in the longitudinal direction thereof (the vertical direction). The section 60-1 is divided into seven sections 71 to 77. The portions 71 to 73 whose refractive indices gradually decrease (with portion 71 having the highest refractive index) are sequentially arranged from the middle to a side portion 60-4 of the lens 60, and the portions 71, 74 to 77 whose refractive indices gradually decrease (again with portion 71 having the highest refractive index) are sequentially arranged from the middle to a side portion 60-5 of the lens 60. The section 60-2 is divided into seven sections 61 to 67. The portions 61 to 64 whose refractive indices gradually decrease (with portion 61 having the highest refractive index) are sequentially arranged from the middle to the side portion 60-4 of the lens 60, and the portions 61, 65 to 67 whose refractive indices gradually decrease (again with portion 61 having the highest refractive index) are sequentially arranged from the middle to the side portion 60-5 of the lens 60. The section 60-3 is divided into seven sections 81 to 87. The portions 81 to 85 whose refractive indices gradually decrease (with portion 81 having the highest refractive index) are sequentially arranged from the middle to the side portion 60-4 of the lens 60, and the portions 81, 86 and 87 whose refractive indices gradually decrease (again with portion 81 having the highest refractive index) are sequentially arranged from the middle to the side portion 60-5 of the lens 60. Each of the portions 71 to 77, 61 to 67, and 81 to 87 does not extend throughout the whole length of the lens 60, that is, does not extend from the upper end to the lower end of the lens 60.

In the embodiment depicted in FIG. 3A, from the middle of the RF lens 131 to the side 131-3 and from the middle to the side 131-4, the RF lens 131 has a symmetric distribution of refractive indices. The distribution of the refractive indices includes the values of the refractive indices of each portion, as well as the shapes, sizes (including lengths, widths, thicknesses, etc.) of each portion and their positions in the RF lens. It will be appreciated that the distribution of the refractive indices from the middle to the first side of the RF lens may be different from the distribution of the refractive indices from the middle to the second side of the RF lens. For example, as shown in FIG. 5, the distribution of the refractive indices from the middle of the lens 60 to the side portion 60-4 is different from the distribution of the refractive indices from the middle to the side portion 60-5.

In the embodiment depicted in FIG. 3A, the widths of the ones of portions 11 to 14 that are closer to the middle of the lens 131 are greater than or equal to the widths of the portions that are closer to the sides 131-3 or 131-4, that is, the portion having a larger refractive index is at least as wide or wider than adjacent portion(s) that have a smaller refractive index. For example, in an embodiment, from the middle to the opposed sides 131-3, 131-4 of RF lens 131, the widths of the plurality of portions 11 to 14 gradually decrease. Electromagnetic radiation emitted by the radiating elements 114 enters the lens 131 from the surface 131-1 and deflects toward the middle having a larger refractive index when passing inside the RF lens 131, and thus, a path having a larger refractive index that the electromagnetic radiation passes is longer than a path having a smaller refractive index that the electromagnetic radiation passes. Compared to the configuration in which the width of the portion having the larger refractive index is equal to or smaller than the width of the portion having the smaller refractive index, this configuration described above may reduce the thickness of the RF lens under the condition of achieving the same focusing effect, and may achieve a stronger focusing effect under the condition of using the same thickness RF lens.

In some embodiments, the RF lens comprises dielectric materials. The plurality of portions included in the RF lens respectively include dielectric materials having respective dielectric constants such that the plurality of portions respectively have respective refractive indices.

In the embodiment depicted in FIG. 2A, since the second frequency band in which the array 113 operates is lower than the first frequency band in which the arrays 111 and 112 operate, the radiating elements 115 in the array 113 are larger than the radiating elements 114 in the arrays 111 and 112. The distance from the radiating arms of the radiating elements 115 in the array 113 to the outer surface of the backplane 123 is greater than the distance from the surface 131-1, 132-1 of RF lenses 131, 132, respectively, to the outer surfaces of the respective backplanes 121 and 122. This configuration may prevent the RF lenses 131 and 132 from receiving electromagnetic radiation emitted by the array 113, even in the case where the arrangement between the arrays 111, 112 and the array 113 is relatively compact. In some embodiments, at least one of the RF lenses 131 and 132 is formed as at least a portion of the radome 141. In such embodiments, the array 111 and the RF lens 131, and the array 112 and the RF lens 132 may be respectively arranged closer to the respective sides of the antenna, so as to prevent the RF lenses 131 and 132 from receiving electromagnetic radiation emitted by the array 113.

In addition, the base station antenna may also include other conventional components not shown in FIGS. 2A and 2B, such as a plurality of circuit components mounted therein. These circuit components and other structures may include, for example, phase shifters for one or more linear arrays (“linear array” herein referring to a column of radiating elements that are arranged in a vertical direction or a row of radiating elements that are arranged in a horizontal direction), remote electronic tilt (RET) actuators for mechanically adjusting phase shifters, one or more controllers, cable connections, RF transmission lines, etc. A mounting bracket (not shown) may also be provided for mounting the base station antenna to another structure, such as an antenna tower or utility pole.

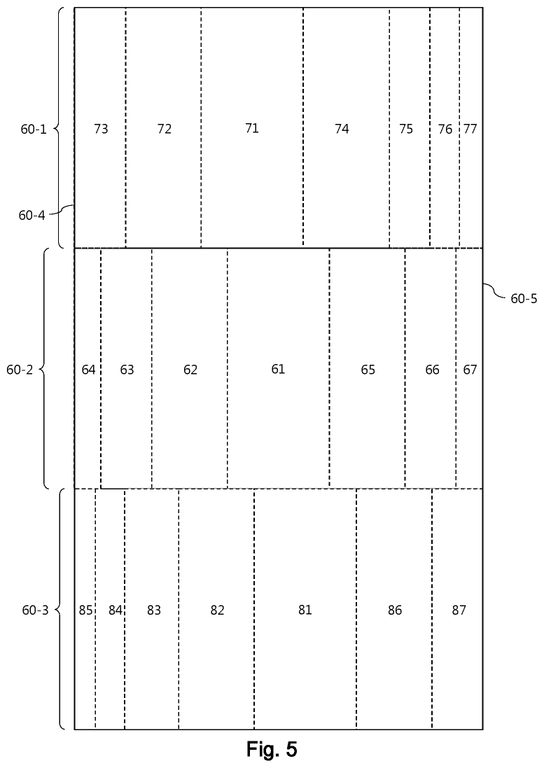

FIG. 6 schematically illustrates a base station antenna according to another embodiment of the present invention. The base station antenna includes backplanes 221 and 222 extending in the vertical direction, first and second arrays of radiating elements 211 respectively mounted on the backplanes 221 and 222, and RF lenses 231 and 232 that are positioned to receive electromagnetic radiation emitted by the first and second arrays. The first array is configured to emit electromagnetic radiation to generate a first antenna beam, and the second array is configured to emit electromagnetic radiation to generate a second antenna beam. The first and second antenna beams have different pointing directions in the azimuth plane. Each array of radiating elements includes a plurality of radiating elements 211. Although FIG. 6 schematically illustrates that each array includes a single column of radiating elements, it will be appreciated that each array may include more than one column in other embodiments. An angle between an outer surface of the backplane 221 and an outer surface of the backplane 222 is greater than 180 degrees. It will be appreciated that any of the RF lenses 231 and 232 may have the configuration of any of the RF lenses described above. In addition, the base station antenna may also include other conventional components not shown in FIG. 6.

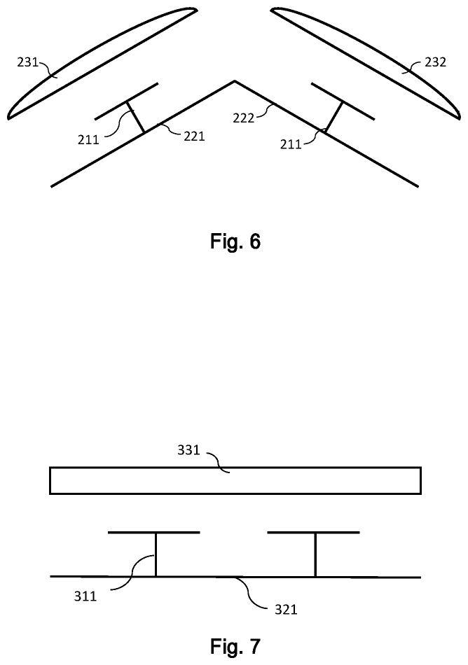

FIG. 7 schematically illustrates a base station antenna according to another embodiment of the present invention. The base station antenna includes a flat backplane 321, an array of radiating elements 311 mounted on the backplane 321, and an RF lens 331 that is positioned to receive electromagnetic radiation emitted by the array. The array includes a plurality of radiating elements 311. Although FIG. 7 schematically illustrates that the array includes two columns of radiating elements 311, it will be appreciated that the array may include fewer or more columns of radiating elements 311. It will be appreciated that the RF lens 331 may have the configuration of any of the RF lenses described above. In addition, the base station antenna may also include other conventional components not shown in FIG. 7.

In the array of radiating elements of the base station antenna according to other embodiments of the present invention, a column of radiating elements may not be arranged in a straight line, for example may be staggered in the horizontal direction. The backplane(s) in the base station antenna according to the other embodiments of the present invention is not limited to being in a flat shape, a V shape, or a V-shape with a flattened vertex as described above. The one or more backplanes may be arranged in a cylindrical shape, such as a cylindrical shape having a triangular horizontal cross section, a rectangular horizontal cross section, or having other polygonal horizontal cross sections.

Embodiments are described herein with respect to operations of base station antennas in a transmitting mode in which an array of radiating elements emits electromagnetic radiation. It will be appreciated that base station antennas according to embodiments of the present invention may operate in a transmitting mode and/or a receiving mode in which an array of radiating elements receives electromagnetic radiation. When the antenna operates in the receiving mode, the RF lens described herein may focus electromagnetic radiation that is received by the array of radiating elements, so as to narrow the beamwidth of the antenna beam for the electromagnetic radiation.

Although some specific embodiments of the present invention have been described in detail with examples, it should be understood by a person skilled in the art that the above examples are only intended to be illustrative but not to limit the scope of the present invention. The embodiments disclosed herein can be combined arbitrarily with each other, without departing from the scope and spirit of the present invention. It should be understood by a person skilled in the art that the above embodiments can be modified without departing from the scope and spirit of the present invention. The scope of the present invention is defined by the attached claims.

1. A base station antenna comprising:
an array of radiating elements configured to emit electromagnetic radiation; and
a radio frequency lens positioned to receive the electromagnetic radiation, the radio frequency lens having a first surface facing the array of radiating elements and a second surface opposite the first surface, the radio frequency lens being divided into a plurality of portions that extend from the first surface to the second surface, respectively, the plurality of portions having respective refractive indices for the electromagnetic radiation,
wherein the plurality of portions are arranged, in a width direction of the radio frequency lens, such that a first of the plurality of portions having the highest refractive index is in a middle portion of the radio frequency lens and others of the plurality of portions having lower refractive indices are on either side of the first of the plurality of portions.

2-4. (canceled)

5. The base station antenna according to claim 1, wherein a width of the radio frequency lens is greater than or equal to a width of the array of radiating elements.

6-7. (canceled)

8. The base station antenna according to claim 1, wherein at least one of the first and second surfaces comprises a substantially flat surface.

9. The base station antenna according to claim 1, wherein the first surface and the second surface are substantially flat surfaces that are substantially parallel to each other.

10. The base station antenna according to claim 1, wherein the radio frequency lens has symmetric distributions of the refractive indices from the middle of the radio frequency lens to respective opposed sides thereof.

11. (canceled)

12. The base station antenna according to claim 1, wherein the refractive indices of the radio frequency lens has a linear, parabolic, or hyperbolic stepwise decrease from the middle of the radio frequency lens to the at least one side thereof.

13. The base station antenna according to claim 1, further comprising a radome that houses the array of radiating elements, wherein the radio frequency lens is formed as at least a portion of the radome.

14. (canceled)

15. The base station antenna according to claim 1, wherein each of the plurality of portions extends from an upper end of the radio frequency lens to a lower end thereof in a vertical direction.

16. The base station antenna according to claim 1, wherein the plurality of portions comprise a first portion that is closer to the middle of the radio frequency lens and a second portion that is closer to the at least one side of the radio frequency lens, and a width of the first portion is greater than or equal to a width of a second portion.

17. (canceled)

18. A base station antenna comprising:
an array of radiating elements;
a radio frequency lens positioned to receive electromagnetic radiation from each radiating element in the array of radiating elements, the radio frequency lens having a first surface facing the array of radiating elements and a second surface opposite the first surface,
wherein the radio frequency lens is divided into first to third portions respectively extending from the first surface to the second surface, extending from an upper end of the radio frequency lens in a vertical direction to a lower end thereof, and having first to third dielectric constants, the first portion being substantially positioned in a middle region of the radio frequency lens, the second and third portions being respectively positioned on opposed sides of the first portion in a width direction of the radio frequency lens, and wherein the first dielectric constant is greater than both the second dielectric constant and the third dielectric constant.

19. The base station antenna according to claim 18, wherein thicknesses of the first to third portions are substantially equal.

20. The base station antenna according to claim 18, wherein a width of the first portion is greater than respective widths of the second portion and the third portion.

21. (canceled)

22. A base station antenna comprising:
a first array of radiating elements configured to emit electromagnetic radiation to generate a first beam;
a second array of radiating elements configured to emit electromagnetic radiation to generate a second beam;
a first backplane, the first array of radiating elements being disposed on an outer surface of the first backplane;
a second backplane, the second array of radiating elements being disposed on an outer surface of the second backplane;
a first radio frequency converging lens positioned to receive the electromagnetic radiation emitted by the first array of radiating elements; and
a second radio frequency converging lens positioned to receive the electromagnetic radiation emitted by the second array of radiating elements,
wherein the first and second backplanes are positioned such that an angle between the outer surface of the first backplane and the outer surface of the second backplane is greater than 180 degrees, such that a horizontal pointing direction of the first beam is different from a horizontal pointing direction of the second beam.

23-26. (canceled)

27. The base station antenna according to claim 22, wherein at least one of the first and second radio frequency converging lenses comprises a first surface facing the corresponding array of radiating elements and a second surface opposite the first surface, the at least one radio frequency converging lens being divided into a plurality of portions that extend from the first surface to the second surface, respectively, the plurality of portions having refractive indices for the electromagnetic radiation that is received by the at least one radio frequency converging lens,
wherein the plurality of portions are arranged, in a width direction of the at least one radio frequency converging lens, such that a first of the plurality of portions having the highest refractive index is in a middle portion of the radio frequency converging lens and others of the plurality of portions having lower refractive indices are on either side of the first of the plurality of portions.

28. (canceled)

29. The base station antenna according to claim 27, wherein at least one of the first and second surfaces comprises a substantially flat surface.

30. The base station antenna according to claim 27, wherein the first surface and the second surface are substantially flat surfaces that are substantially parallel to each other.

31. The base station antenna according to claim 22, wherein the at least one radio frequency converging lens has symmetric distributions of the refractive indices from the middle of the at least one radio frequency converging lens to both sides thereof, respectively.

32-33. (canceled)

34. The base station antenna according to claim 27, wherein the plurality of portions comprise a first portion that is closer to the middle of the at least one radio frequency converging lens and a second portion that is closer to the at least one side thereof, and a width of the first portion is greater than or equal to a width of a second portion.

35-36. (canceled)

37. The base station antenna according to claim 22, wherein at least one of the first and second radio frequency converging lenses has a first surface facing the corresponding array of radiating elements and a second surface opposite the first surface,
wherein the at least one radio frequency converging lens is divided into first to third portions respectively extending from the first surface to the second surface, extending from an upper end of the at least one radio frequency converging lens in a vertical direction to a lower end thereof, and having first to third dielectric constants, the first portion being substantially positioned in a middle region of the at least one radio frequency converging lens, the second and third portions being respectively positioned on both sides of the first portion in a width direction of the at least one radio frequency converging lens, and wherein the first dielectric constant is greater than the second dielectric constant and greater than the third dielectric constant.

38. The base station antenna according to claim 37, wherein thicknesses of the first to third portions are substantially equal.

39-64. (canceled)
